(19) United States
(12) Patent Application Publication
(10) Pub. No.: US 2025/0333870 A1
(43) Pub. Date: Oct. 30, 2025

(54) METAL COMPOUND, METAL RECOVERY ELECTRODE, AND METHOD FOR RECOVERING METALS FROM SPENT ELECTRODES

(71) Applicant: INSTITUT NATIONAL DE LA RECHERCHE SCIENTIFIQUE, Quebec (CA)

(72) Inventors: Fabiola NAVARRO PARDO, Montreal (CA); Ana Berta LOPES CORREIA TAVARES, Verdun (CA)

(21) Appl. No.: 19/185,564

(22) Filed: Apr. 22, 2025

Related U.S. Application Data
(60) Provisional application No. 63/638,462, filed on Apr. 25, 2024.

(51) Int. Cl. C25C 1/06; C22B 11/00; C22B 34/24; C25C 1/20; H01M 6/52; H01M 10/54

(52) U.S. Cl. CPC C25C 1/06; C22B 11/046; C22B 34/24; C25C 1/20; H01M 6/52; H01M 10/54

(57) ABSTRACT

A method for the electrochemical recovery of a metal from a spent electrode is provided. The method comprises the steps of providing an electrochemical cell comprising a metal recovery electrode as a working electrode, the spent electrode as a counter-electrode, and an electrolyte between the working electrode and the counter-electrode, and performing cyclic voltammetry on the metal recovery electrode, thereby dissolving the metal from the spent electrode and adsorbing dissolved atoms of the metal on the metal recovery electrode, thereby recovering the metal and forming a composite electrode. The metal recovery electrode comprising a metal compound on a conducting support and the metal compound is made by a method comprising reacting a metal oxalate or an ammonium metal oxalate, wherein the metal is a group 4 to 6 metal, with a chalcogenide or an organochalcogenide.

### CROSS REFERENCE TO RELATED APPLICATIONS

This application claims benefit, under 35 U.S.C. § 119(e), of U.S. provisional application Ser. No. 63/638,462, filed on Apr. 25, 2024. All documents above are incorporated herein in their entirety by reference.

### FIELD OF THE INVENTION

The present invention relates to metal compound and a metal recovery electrode comprising this compound. More specifically, the present invention is concerned with the use of this compound and electrode for the recovery of a metal from a spent electrode.

### BACKGROUND OF THE INVENTION

The high content of critical materials within end-of-life electrodes makes their recycling economically attractive. Furthermore, their higher concentration compared to ores significantly reduces the environmental impact of recycling compared to mineral extraction.¹ End-of-life processes focused on the recovery of active materials within electrodes of fuel cells and electrolyzers are needed to advance the hydrogen economy. State-of-the-art active materials in proton exchange membrane (PEM) fuel cells and electrolyzers consist of platinum group metal (PGM) catalysts.

The current strategies to recover critical materials from end-of-life electrodes in clean energy devices are based on hydrometallurgical and pyro-hydrometallurgical methods.² The core component of PEM fuel cells and electrolyzers is the membrane electrode assembly (MEA), which comprises two electrodes (anode and cathode) separated by a polymeric membrane as the electrolyte. However, pyrometallurgy is not suitable for processing large volumes of MEAs due to the fluorine compounds present in the binders/membranes used to manufacture the electrodes. These fluoropolymers combust to release extremely harmful hydrogen fluoride, chlorofluorocarbons and sulfur oxides.³ On the other hand, the hydrometallurgical process requires the use of strong acids and oxidizing agents that can react with the fluorinated compounds producing highly toxic vapors.

To circumvent the problems arising from the fluorine content of the MEAs, alternative processes have been developed. WO 2006/024507A1⁴ details a process in which a supercritical medium is used to separate fluorine-containing constituents from MEAs followed by a pyro- or hydro-metallurgical step to recover PGMs. Similarly, WO 2015/010793A3⁵ describes a method where the MEA is first crushed, then subjected to an ultrasonic treatment in a water-alcohol mixture to filter the PGM loaded solvent and recover it using a conventional thermal method. Acidic leaching is another commonly used approach to recover PGMs from secondary sources or spent catalysts. This technique is based on the ability of PGMs to form stable aqueous complexes with ligands such as cyanide, halide, sulfite, and thiosulfate ions.⁶ A more recent process, taught in WO 2018/138427A1⁷, has tackled the recovery of composite Pt/Co electrodes by leaching methods. The drawbacks of all these methods are that they are time-consuming, energy-intensive and involve multiple unit operations and hazardous chemicals.⁸

Electrochemical dissolution methods use milder and safer operation conditions than state-of-the-art recycling processes.^{9, 10} This method relies on controlling the electrode potential to form surface oxides on PGMs followed by reduction of these species and triggering PGM dissolution into bulk acidic electrolyte. Similarly to the leaching methods, the anion (X) in the acidic electrolyte influences the PGM electrochemical dissolution through its interaction with the metal (M) surface to produce M-X containing complexes.¹¹ WO 2019/211318A1⁹ describes a method to dissolve PGMs from GDE (gas diffusion electrodes) making use of “surface switching species” (SSS). In this method, the working electrode (PGMs from the GDE) is cycled in the presence of HCl and the SSS (group 10-12 metals). These species block the working electrode surface when cycled towards the cathodic direction inhibiting the PGM redeposition and enhancing its dissolution whereas the SSS are dissolved when cycled towards the anodic direction. In another step, the recovery of the dissolved PGMs was demonstrated by redepositing them into a second working electrode.

On another subject, earth-abundant transition metal compounds from Groups 4 to 6 (e.g., Ti, Zr, Nb, Ta, Mo, W) are stable in the harsh acidic conditions in which PEM fuel cells and electrolyzers operate. On the other hand, their recent proliferation when synthetized into transition metal sulfides (TMS), such as Nb_{1.35}S₂/SiO₂, is due to their promising results as electrocatalysts for hydrogen evolution reaction.¹²⁻¹³ Niobium sulfides are most often synthesized by chemical vapor deposition¹³⁻¹⁵ where NbCl₅ and elemental sulfur are directly combined in evacuated silica tubes, requiring high-temperature and long residence times.¹⁶⁻¹⁷

Solution chemistry methods can also be used to produce nano- and micro-structured materials.¹⁸ An example is the electrochemical exfoliation from bulk NbS₂.¹⁹ However, the competitive activity of these NbS₂ electrocatalyst is achieved when the nanoplatelets thicknesses are reduced by using ultrasonication (10h)¹⁹. NbS₂ obtained by CVD processes also requires increasing the surface area. which has been achieved by intercalating a lithium salt²⁰. The most competitive performances have been achieved by electrochemical pre-conditioning which consists of conducting thousands (>5000×) of potential cycles.¹⁴ In most cases, NbCl₅ is used as a precursor; this compound and the lithium salt are moisture sensitive and must be handled under inert gas. The use of organic compounds and more sustainable routes is therefore desired.

Electrodeposition can also be used to obtain self-supported nanostructured materials for fuel cell, electrolyzers, and battery/capacitor applications. This approach promotes an electrically intimate contact with an electrode that can also serve as a current collector. However, this technique has hardly been used to obtain Nb-based compounds. A reason is that the cathodic electrodeposition of niobium compounds requires a very negative reduction potential for Nb³⁺ (−1.1 V vs. NHE) which makes H₂ evolution unavoidable in aqueous solutions.²¹ Consequently, the electrodeposition technique has been limited to obtaining Nb₂O₅ films²¹⁻²⁴, with no Nb/S compound obtained by this approach whatsoever.

### SUMMARY OF THE INVENTION

In accordance with the present invention, there is provided:
1. A method of manufacture of a metal compound, the method comprising:
   reacting a metal carboxylate, wherein the metal is a group 4 to 6 metal,
   with
   a chalcogenide or an organochalcogenide.
2. The method of embodiment 1, wherein the chalcogenide comprises at least one S, Se, or Te atom, preferably at least one S atom.
3. The method of embodiment 1 or 2, wherein the organochalcogenide comprises at least one S, Se, or Te atom, preferably at least one S atom.
4. The method of any one of embodiments 1 to 3, wherein the organochalcogenide is an organosulfur, preferably thiophene, a thiol, a thiolane, a polysulfide, or thiazole.
5. The method of any one of embodiments 1 to 4, wherein the organochalcogenide comprises an amino, carboxylate, carbonyl, or alkyl group, preferably an amino or carbonyl group.
6. The method of any one of embodiments 1 to 5, wherein the organochalcogenide is thiourea.
7. The method of any one of embodiments 1 to 6, wherein the chalcogenide is used.
8. The method of any one of embodiments 1 to 6, wherein the organochalcogenide is used.
9. The method of any one of embodiments 1 to 10, wherein the group 4 to 6 metal is Ti, Zr, Nb, Ta, Hf, Mo, or W, preferably niobium.
10. The method of any one of embodiments 1 to 10, wherein the metal carboxylate is a compound comprising the group 4 to 6 metal coordinated with one or more carboxylate ligand, optionally one or more other ligands, and optionally one or more counterions.
11. The method of embodiment 10, wherein the carboxylate ligand is a monodentate carboxylate ligand, a bidentate carboxylate ligand, or a tridentate carboxylate ligand.
12. The method of embodiment 11, wherein the carboxylate ligand is a monodentate carboxylate ligand, preferably of formula (I):

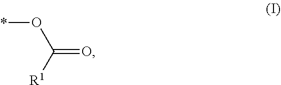

wherein R¹ is a hydrogen atom or a monovalent organic radical.
13. The method of embodiment 12, wherein R¹¹ is a hydrogen atom, R¹¹, —O—(C═O)—R¹², —(C═O)—O—R¹², —(C═O)—R¹², —O—R¹², wherein:
   R¹¹ is alkyl, alkenyl, alkynyl, or alkenynyl (preferably alkyl), each of being unsubstituted or substituted with one or more of —OH, —COOH, and/or —C(═O)H (preferably —OH and/or —COOH), and
   R¹² is a hydrogen atom, alkyl, alkenyl, alkynyl, or alkenynyl (preferably a hydrogen atom or alkyl), wherein the alkyl, alkenyl, alkynyl, or alkenynyl is unsubstituted or substituted with one or more of —OH, —COOH, and/or —C(═O)H (preferably —OH and/or —COOH).
14. The method of embodiment 12 or 13, wherein, R¹ is a hydrogen atom, —COOH, —CH(OH)—CH(OH)—COOH, or —CH₂—C(OH)(COOH)—CH₂—COOH.
15. The method of embodiment 11, wherein the carboxylate ligand is a bidentate carboxylate ligand, preferably of formula (II):

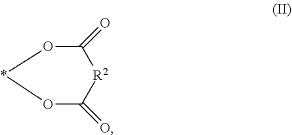

wherein R² is a covalent bond or a bivalent organic radical.
16. The method of embodiment 15, wherein R² is a covalent bond, —R²¹—, —O—(C═O)—R²²—, —R²²—O—(C═O)—, —(C═O)—O—R²²—, —R²²—(C═O)—O—, —(C═O)—R²²—, —R²²—(C═O)—, —O—R²²—, —R²²—O—, wherein:
   R²¹ is alkylene, alkenylene, alkynylene, or alkenynylene (preferably alkylene), each of which being unsubstituted or substituted with one or more of —OH, —COOH, and/or —C(═O)H (preferably —OH and/or —COOH), and
   R²² is a covalent bond or alkylene, alkenylene, alkynylene, or alkenynylene (preferably a covalent bond or alkylene), wherein the alkylene, alkenylene, alkynylene, or alkenynylene is unsubstituted or substituted with one or more of —OH, —COOH, and/or —C(═O)H (preferably —OH and/or —COOH).
17. The method of embodiment 15 or 16, wherein R² is a covalent bond or alkylene (preferably propylene, more preferably n-propylene), said alkylene being unsubstituted or substituted as noted above; preferably substituted; more preferably substituted with —OH and/or —COOH.
18. The method of any one of embodiments 15 to 17, wherein R² is —CH(OH)—CH(OH)—, or —CH₂—C(OH)(COOH)—CH₂—.
19. The method of embodiment 11, wherein the carboxylate ligand is a tridentate carboxylate ligand, preferably of formula (III):

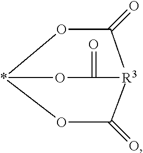

wherein R³ is a trivalent organic radical.
20. The method of embodiment 19, wherein R³ is alkylidyne, alkenylidyne, alkynylidyne, or alkenynylidyne, wherein the alkylidyne, alkenylidyne, alkynylidyne, or alkenynylidyne is unsubstituted or substituted with one or more of —OH, —COOH, and/or —C(═O)H (preferably —OH and/or —COOH), and wherein the alkylidyne uninterrupted or interrupted by one or more of —O—, —(C═O)—, —O—(C═O)—, —(C═O)—O—.
21. The method of embodiment 19 or 20, wherein R³ is alkylidyne. In most preferred embodiments, the alkylidyne is propylidyne, more preferably n-propylidyne).
22. The method of embodiment 20 or 21, wherein the alkylidyne, alkenylidyne, alkynylidyne, or alkenynylidyne (preferably alkylidyne) is uninterrupted.
23. The method of any one of embodiments 20 to 22, wherein the alkylidyne, alkenylidyne, alkynylidyne, or alkenynylidyne (preferably alkylidyne) is substituted as noted above; more preferably substituted with —OH and/or —COOH; yet more preferably substituted with —OH.
24. The method of any one of embodiments 20 to 23, wherein R³ is

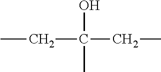

(tridentate citrate ligand).
25. The method of any one of embodiments 10 to 24, wherein the metal carboxylate comprises said one or more other ligands
26. The method of embodiment 25, wherein said other ligands are ═O and/or —OH₂.
27. The method of embodiment 26, wherein the metal carboxylate comprises:
   one or more (preferably one) ═O,
   one or more (preferably two) —OH₂, or
   both one or more (preferably one)=O and one or more (preferably two) —OH₂.
28. The method of any one of embodiments 10 to 24, wherein the metal carboxylate comprises no other ligands.
29. The method of any one of embodiments 10 to 28, wherein the metal carboxylate comprises said one or more counterions.
30. The method of embodiment 29, wherein said one or more counterions are NH₄⁺ (ammonium) or ions of alkaline metals and alkaline earth metals, such as sodium, potassium, calcium, and magnesium.
31. The method of embodiment 30, wherein said one or more counterions is NH₄⁺.
32. The method of any one of embodiments 1 to 24, wherein the metal carboxylate is of formula (IV):

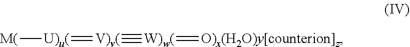

wherein
   M is the group 4 to 6 metal,
   U is a monodentate carboxylate ligand as defined above,
   V is a bidentate carboxylate ligand as defined above,
   W is a tridentate carboxylate ligand as defined above,
   u is 0 or more,
   v is 0 or more,
   w is 0 or more,
   x is 0 or more,
   y is 0 or more, and
   z is 0 or more,
   with the proviso that at least one of u, v, and w is 1 or more.
33. The method of embodiment 29, wherein u is 1 or more and v=w=0; or v is 1 or more and u=w=0.
34. The method of embodiment 29, wherein the group 4 to 6 metal is niobium, preferably wherein u=w=0, v is 1 or more (preferably 2), x is 1 or more (preferably 1), y is 1 or more (preferably 2), and/or (preferably and) z is 1; most preferably wherein [counterion]_{z} represents one counterion having a charge of +1, preferably NH₄⁺.
35. The method of embodiment 29, wherein the group 4 to 6 metal is niobium, preferably u is 1 or more (preferably 5), v=w=0, x is 0, y is 0, and/or (preferably and) z is 0.
36. The method of any one of embodiments 1 to 35, wherein the carboxylate ligand comprises one or more monodentate oxalate ligand(s) and/or (preferably or) one or more bidentate oxalate ligand(s).
37. The method of any one of embodiments 1 to 35, wherein the metal carboxylate is a metal oxalate or an ammonium metal oxalate, preferably an ammonium metal oxalate.
38. The method of embodiment 37, wherein the metal oxalate comprises:
   one of more oxalate ligand as the carboxylate ligand (preferably the oxalate ligand is a monodentate oxalate ligand, i.e., u is 1 or more; and preferably v=w=0);
   no counterion (z is 0); and/or (preferably and)
   no other ligand (x=y=0).
39. The method of any one of embodiments 1 to 35, wherein the metal oxalate is niobium (V) hydrogen oxalate:

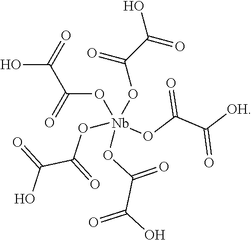

40. The method of embodiment 37, wherein the ammonium metal oxalate is a metal carboxylate comprising at least one monodentate oxalate ligand (as U, with u being 1 or more) or bidentate oxalate ligand (as V, with v being 1 or more) as the carboxylate ligand and one or more ammonium counterion (i.e., [counterion] is NH₄⁺ and z is 1 or more).
41. The method of embodiment 37 or 40, wherein the ammonium metal oxalate comprises:
   one or more bidentate oxalate ligands as the carboxylate ligand, i.e., V is a bidentate oxalate ligand and v is 1 or more (preferably 2), u=w=0, and
   one or more other ligand, preferably one or more ═O (x is 1 or more) and/or one or more water molecules (y is 1 or more), preferably both.
42. The method of embodiment 37 or 40, wherein the ammonium metal oxalate is ammonium niobium oxalate, which is:

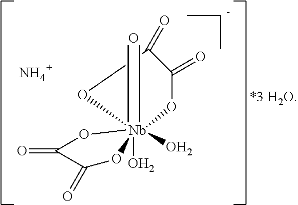

43. The method of any one of embodiments 1 to 35, wherein the metal carboxylate is in hydrated form or in non-hydrated form, preferably in hydrated form.
44. The method of any one of embodiments 1 to 43, wherein the ammonium metal oxalate is ammonium niobium oxalate
45. The method of any one of embodiments 1 to 44, wherein comprising:
   reacting the metal carboxylate with hydrogen peroxide and citric acid to form a soluble peroxo-citrato-metal complex, and
   then reacting the peroxo-citrato-metal complex with the chalcogenide or the organochalcogenide, thereby producing the metal compound.
46. The method of any one of embodiments 1 to 45, wherein a colloidal suspension of particles of the metal compound is produced.
47. A metal compound made by the method of any one of embodiments 1 to 46.
48. The metal compound of embodiment 47, comprising niobium (Nb), sulfur(S), oxygen (O), nitrogen (N), and carbon (C).
49. The metal compound of embodiment 47 or 48, consisting of niobium (Nb), sulfur(S), oxygen (O), nitrogen (N), and carbon (C).
50. The metal compound of any one of embodiments 47 to 49, having a Raman spectrum comprising bands at about 84, about 152, about 218, about 246, about 438, and about 474 cm⁻¹; preferably having a Raman spectrum is as shown in FIG. 25.
51. The metal compound of any one of embodiments 47 to 50, being supported on a support, preferably a conducting support.
52. The metal compound any one of embodiments 47 to 51, being for the electrochemical recovery of a metal from a spent electrode
53. Use of the metal compound of any one of embodiments 47 to 51 for the electrochemical recovery of a metal from a spent electrode.
54. A metal recovery electrode comprising the metal compound any one of embodiments 47 to 52 on a conducting support.
55. The metal recovery electrode of embodiment 54, wherein the conducting support is:
   a carbon-based support, such as carbon-fiber paper, carbon cloth, carbon foams, or carbon felt,
   a carbon material, such as:
   carbon black,
   a porous carbon material, a fullerene, carbon nanotubes, carbon fibers, carbon filaments, carbon xerogel, carbon aerogel, a nanocage carbon, carbon nanohorns, carbon nano-onions, carbon nano-capsules, or their graphitic forms,
   a graphene-type material, such as monolayer graphene, few-layer graphene materials, reduced graphene oxide, or graphene oxide,
   a heteroatom-doped carbon material or a heteroatom-doped graphene-type materials, wherein the heteroatom is preferably N, S, or P, and
   carbon nitride or graphitic carbon nitride,
   a mesh, a foam, a felt, or a porous transport layer of sintered nanoparticles of:
   one or more of Cu, Zn, Sb, Ag, Au, Pt, and Ru
   a transition metal carbide, wherein the transition metal is preferably Ti, V, Cr, Zr, Nb, Mo, Hf, Ta, W, or Fe,
   a transition metal nitride, wherein the metal is preferably Ti, V, Cr, Zr, Nb, Mo, Hf, Ta, W, Mn, Ni, Co, Fe, Cu;
   or
   a conductive transition metal oxide, such as RuO₂ and IrO₂.
56. The metal recovery electrode of embodiment 54 or 55, wherein the conducting support is carbon fiber paper.
57. The metal recovery electrode of any one of embodiments 54 to 56, being for the electrochemical recovery of a metal from a spent electrode
58. Use of the metal recovery electrode of any one of embodiments 54 to 56 for the electrochemical recovery of a metal from a spent electrode.
59. A method for manufacturing the metal recovery electrode of any one of embodiments 54 to 56, the method comprising depositing the metal compound on the conducting support.
60. The method of embodiment 59, comprising electrodepositing the metal compound on the conducting support.
61. The method of embodiment 60, wherein the electrodepositing comprises using the conducting support as a working electrode, using a counter-electrode, and using an aqueous suspension of particles of the metal compound as an electrolyte between the working electrode and the counter-electrode.
62. The method of embodiment 61, wherein the counter-electrode is a carbon rod, carbon fiber paper, or a graphite plate; preferably carbon fiber paper.
63. The method of embodiment 61 or 62, wherein a reference electrode, such as Ag/AgCl, is be used for the electrodepositing.
64. A method for the electrochemical recovery of a metal from a spent electrode, the method comprising the steps of:
   A) providing an electrochemical cell comprising the metal recovery electrode of any one of embodiments 54 to 57 as a working electrode, the spent electrode as a counter-electrode, and an electrolyte between the working electrode and the counter-electrode, and
   B) applying a potential or a current between the working electrode and the counter-electrode to dissolve the metal from the spent electrode and electrodeposit dissolved atoms of the metal on the metal recovery electrode, thereby recovering the metal and forming a composite electrode.
65. The method of embodiment 64, wherein a reference electrode, such as Ag/AgCl, is used for step B).
66. The method of embodiment 64 or 65, wherein the metal to be recovered from the spent electrode is a noble metal (preferably Pt, Pd, Ir, Au, or Ag), Ni, or Cu, preferably Pt.
67. The method of any one of embodiments 64 to 66, wherein the spent electrode is an electrode from a membrane electrode assembly of a proton exchange membrane fuel cell, from an electrolyzer, from a metal-air battery, from a reversible fuel cell, from a water splitting device, or from a solar energy conversion device.
68. The method of any one of embodiments 64 or 67, further comprising the step c) of using the composite electrode as a gas diffusion electrode, preferably for hydrogen evolution.

### BRIEF DESCRIPTION OF THE DRAWINGS

In the appended drawings:

FIG. 1 illustrates the process for recycling and upcycling PGMs to produce a composite gas diffusion electrode.

FIG. 2 shows a scanning electron microscopy (SEM) image of the self-supported earth-abundant compound on carbon fiber paper as prepared in Example 1.

FIG. 3 shows the energy dispersive X-ray (EDX) spectrum of the earth-abundant electrode prepared in Example 1.

FIG. 4 shows the survey X-ray photon spectroscopy (XPS) spectrum of the earth-abundant electrode prepared in Example 1.

FIG. 5 shows the high-resolution XPS spectrum of the earth-abundant electrode prepared in Example 1, centered in the niobium (Nb) 3d region.

FIG. 6 shows the high-resolution XPS spectrum of the earth-abundant electrode prepared in Example 1, centered in the sulfur(S) 3d region.

FIG. 7 shows the high-resolution XPS spectrum of the earth-abundant electrode prepared in Example 1, centered in the oxygen (O) 1s region.

FIG. 8 shows the high-resolution XPS spectrum of the earth-abundant electrode prepared in Example 1, centered in the nitrogen (N) 1s region.

FIG. 9 shows the cyclic voltammograms (CV) for the progressive Pt dissolution from a planar electrode and the deposition to produce the Pt/earth-abundant electrode prepared in Example 2. Inset represents the typical CV curves of the earth-abundant electrode (1×) and the Pt/earth-abundant electrode (2000×). All measurements were recorded in 0.5M H₂SO₄ at a scan rate of 100 mV s⁻¹.

FIG. 10 shows the scanning electron microscopy (SEM) image of the Pt/earth-abundant electrode prepared in Example 2.

FIG. 11 shows the EDX spectrum of the composite Pt/earth-abundant electrode prepared in Example 2.

FIG. 12 shows the EDX mapping of platinum (Pt) in the Pt/earth-abundant electrode prepared in Example 2.

FIG. 13 shows the EDX mapping of Nb in the Pt/earth-abundant electrode prepared in Example 2.

FIG. 14 shows the EDX mapping of S in the Pt/earth-abundant electrode in Example 2.

FIG. 15 shows the EDX mapping of O in the Pt/earth-abundant electrode in Example 2.

FIG. 16 shows the EDX mapping of C in the Pt/earth-abundant electrode prepared in Example 2.

FIG. 17 shows the survey XPS spectrum of Pt/earth-abundant electrode prepared in Example 2.

FIG. 18 shows the high-resolution XPS spectrum of the Pt/earth-abundant electrode prepared in Example 2, centered in the Pt 4f region.

FIG. 19 shows the high-resolution XPS spectrum of the Pt/earth-abundant electrode prepared in Example 2, centered in the Nb 3d region.

FIG. 20 shows the high-resolution XPS spectrum of the Pt/earth-abundant electrode prepared in Example 2, centered in the S 2p region.

FIG. 21 shows the high-resolution XPS spectrum of the Pt/earth-abundant electrode prepared in Example 2, centered in the O 1s region.

FIG. 22 shows the performance towards the hydrogen evolution reaction (HER) of the Pt/earth-abundant composite electrode prepared in Example 2 as a function of the progressive cycling.

FIG. 23 shows the CVs for the progressive Pt dissolution from a Pt/C gas diffusion electrode and the deposition to produce the Pt/earth-abundant electrode prepared in Example 3. Inset represents the typical CV curves of the earth-abundant electrode (1×) and the Pt/earth-abundant electrode (2000×). All measurements were recorded in 0.5M H₂SO₄ at a scan rate of 100 mV s⁻¹.

FIG. 24 shows the performance towards the HER of the Pt/earth-abundant composite electrode prepared in Example 3 as a function of the progressive cycling.

FIG. 25 shows the full range Raman spectrum and zoom-in of the region corresponding to the earth-abundant compound prepared in Example 1.

FIG. 26 shows the Raman spectrum of the Pt/earth-abundant electrode prepared in Example 2.

### DETAILED DESCRIPTION OF THE INVENTION

Turning now to the invention in more detail, in a first aspect of the invention, there is provided a metal compound made by the method described below. There is also provided a metal recovery electrode comprising this metal compound on a conducting support. An electrochemical method for the manufacturing of the metal recovery electrode is also provided.

In related aspects of the invention, uses of the metal compound and the metal recovery electrode are provided. Thus, in embodiments, the metal compound is for the electrochemical recovery of a metal from a spent electrode. Similarly, in embodiments, the metal recovery electrode is for the electrochemical recovery of a metal from a spent electrode.

In other related aspects of the invention, there is also provided the use of the metal compound for the electrochemical recovery of a metal from a spent electrode as well as the use of the metal recovery electrode for the electrochemical recovery of a metal from a spent electrode.

In yet another related aspect of the invention, there is provided a method for the electrochemical recovery of a metal from a spent electrode, the method comprising the steps of:
A) providing an electrochemical cell comprising the metal recovery electrode as a working electrode, the spent electrode as a counter-electrode, and an electrolyte between the working electrode and the counter-electrode, and
B) performing cyclic voltammetry on the metal recovery electrode, thereby dissolving the metal from the spent electrode and adsorbing dissolved atoms of the metal on the metal recovery electrode, thereby recovering the metal and forming a composite electrode.

This method allows the recycling of platinum group metals (PGMs) and other metals and their upcycling into useful composite electrodes.

The above combination of two electrochemical methods to 1) directly produce the metal recovery electrode (self-supported composite electrode using earth-abundant materials) and then to 2) recover a metal from a spent electrode allows reusing PGMs (and other metals) thus decreasing the amount of PGMs that is extracted from ores and PGMs sent to landfill, and favoring the controlled disassembly of the electrodes, incorporating a potential end-of-life design.

The present invention takes advantage of the fact that Group 5 electrocatalysts with terminated sulfur chalcogen ligands act as trapping sites for Pt deposition, thus allowing the electrochemical recovery of Pt nanoparticles and their reuse as composite electrodes. Hence, the present invention allows recycling and upcycling PGMs (and others) using a metal recovery electrode based on an earth-abundant compound obtained from a cost-efficient and low-environmental risk electrochemical method.

In preferred embodiments below, we describe the manufacture of a precursor colloidal suspension of the metal compound comprising a group 4 to 6 transition metal and chalcogen species, which are deposited onto a support by electrodeposition to make a metal recovery electrode. Cyclic voltammetry is subsequently employed to dissolve Pt nanoparticles from spent Pt-containing electrodes and the metal recovery electrode is used to facilitate the recovery of platinum nanoparticles by the trapping effect of the chalcogen species and to produce a composite electrode with remarkable performance towards the hydrogen evolution reaction in acidic media.

This present invention represents a sustainable approach associated with safer operating conditions than conventional pyrometallurgical and hydrometallurgical technologies.

### the Metal Compound & its Method of Manufacture

The present invention provides a metal compound made by a method comprising:
reacting a metal carboxylate, wherein the metal is a group 4 to 6 metal,
with
a chalcogenide or an organochalcogenide.

The invention also relates to a method of manufacture of a metal compound comprising
reacting a metal carboxylate, wherein the metal is a group 4 to 6 metal,
with
a chalcogenide or an organochalcogenide.

Herein, a “group 4 to 6 metal” is a metal from group 4 to 6 of the periodic table according to the modern IUPAC notation. Preferred group 4 to 6 metals include Ti, Zr, Nb, Ta, Hf, Mo, and W. A most preferred group 4 to 6 metal is niobium (Nb).

Herein, a “metal carboxylate” is a compound comprising the group 4 to 6 metal coordinated with one or more carboxylate ligand, optionally one or more other ligands, and optionally one or more counterions.

The carboxylate ligand can be a monodentate carboxylate ligand, a bidentate carboxylate ligand, or a tridentate carboxylate ligand.

The monodentate carboxylate ligand can be of formula (I):

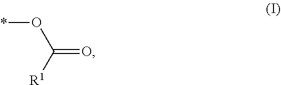

wherein R¹ is a hydrogen atom or a monovalent organic radical. Note that * represents the point of attachment of the group 4 to 6 metal.

In preferred embodiments, R¹ is a hydrogen atom, R¹¹, —O—(C═O)—R¹², —(C═O)—O—R¹², —(C═O)—R¹², —O—R¹², wherein:
R¹¹ is alkyl, alkenyl, alkynyl, or alkenynyl (preferably alkyl), each of being unsubstituted or substituted with one or more of —OH, —COOH, and/or —C(═O)H (preferably —OH and/or —COOH), and
R¹² is a hydrogen atom, alkyl, alkenyl, alkynyl, or alkenynyl (preferably a hydrogen atom or alkyl), wherein the alkyl, alkenyl, alkynyl, or alkenynyl is unsubstituted or substituted with one or more of —OH, —COOH, and/or —C(═O)H (preferably —OH and/or —COOH).

In most preferred embodiments, R¹ is:
a hydrogen atom (formate ligand),
—COOH (oxalate monodentate ligand),
—CH(OH)—CH(OH)—COOH (tartrate monodentate ligand), or
—CH₂—C(OH)(COOH)—CH₂—COOH (citrate monodentate ligand).

The bidentate carboxylate ligand can be of formula (II):

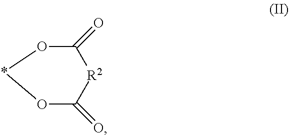

wherein R² is a covalent bond or a bivalent organic radical. Note that * represents the point of attachment of the group 4 to 6 metal.

In preferred embodiments, R² is a covalent bond, —R²¹—, —O—(C═O)—R²²—, —R²²—O—(C═O)—, —(C═O)—O—R²², —R²²—(C═O)—O—, —(C═O)—R²²—, —R²²—(C═O)—, —O—R²²—, —R²²—O—, wherein:
R²¹ is alkylene, alkenylene, alkynylene, or alkenynylene (preferably alkylene), each of which being unsubstituted or substituted with one or more of —OH, —COOH, and/or —C(═O)H (preferably —OH and/or —COOH), and
R²² is a covalent bond or alkylene, alkenylene, alkynylene, or alkenynylene (preferably a covalent bond or alkylene), wherein the alkylene, alkenylene, alkynylene, or alkenynylene is unsubstituted or substituted with one or more of —OH, —COOH, and/or —C(═O)H (preferably —OH and/or —COOH).

In most preferred embodiments, R² is
a covalent bond (bidentate oxalate ligand) or
alkylene (preferably propylene, more preferably n-propylene), said alkylene being unsubstituted or substituted as noted above; preferably substituted; more preferably substituted with —OH and/or —COOH.

Most preferably R² is:
—CH(OH)—CH(OH)— (bidentate tartrate ligand), or
—CH₂—C(OH)(COOH)—CH₂— (bidentate citrate ligand).

The tridentate carboxylate ligand can be of formula (III):

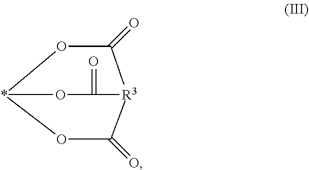

wherein R³ is a trivalent organic radical. Note that * represents the point of attachment of the group 4 to 6 metal.

In preferred embodiments, R³ is alkylidyne, alkenylidyne, alkynylidyne, or alkenynylidyne, wherein the alkylidyne, alkenylidyne, alkynylidyne, or alkenynylidyne is unsubstituted or substituted with one or more of —OH, —COOH, and/or —C(═O)H (preferably —OH and/or —COOH), and wherein the alkylidyne uninterrupted or interrupted by one or more of —O—, —(C═O)—, —O—(C═O)—, —(C═O)—O—.

In preferred embodiments, R³ is alkylidyne. In most preferred embodiments, the alkylidyne is propylidyne, more preferably n-propylidyne).

In embodiments, the alkylidyne, alkenylidyne, alkynylidyne, or alkenynylidyne (preferably alkylidyne) is uninterrupted. In embodiments, the alkylidyne, alkenylidyne, alkynylidyne, or alkenynylidyne (preferably alkylidyne) is substituted as noted above; more preferably substituted with —OH and/or —COOH; yet more preferably substituted with —OH.

Most preferably, R³ is

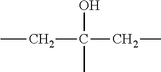

(tridentate citrate ligand).

As noted above, the metal carboxylate optionally comprises one or more other ligands. Non-limiting examples of such other ligands include ═O, and —OH₂ (water). In preferred embodiments, the metal carboxylate comprises:
one or more (preferably one) ═O,
one or more (preferably two) —OH₂, or
both one or more (preferably one)=O and one or more (preferably two) —OH₂.

In alternative preferred embodiments, the metal carboxylate comprises no other ligands.

As noted above, the metal carboxylate optionally comprises one or more counterions. Non-limiting examples of counterion include NH₄⁺ (ammonium) as well as ions of alkaline metals and alkaline earth metals (i.e. groups 1 and 2 of the periodic table), such as sodium, potassium, calcium, and magnesium. Preferred counterions include NH₄⁺.

In preferred embodiments, the metal carboxylate is of formula (IV):

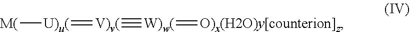

wherein
M is the group 4 to 6 metal,
U is a monodentate carboxylate ligand as defined above,
V is a bidentate carboxylate ligand as defined above,
W is a tridentate carboxylate ligand as defined above,
u is 0 or more,
v is 0 or more,
w is 0 or more,
x is 0 or more,
y is 0 or more, and
z is 0 or more,
   with the proviso that at least one of u, v, and w is 1 or more.

In preferred embodiments, u is 1 or more and v=w=0; or v is 1 or more and u=w=0.

It will be apparent to the skilled person that the number and nature of the carboxylate ligand(s) and of the optional other ligands are selected according to the valency of the metal; and that the number and nature of the counterion(s) are selected such that the counterion(s) total charge ensures the neutrality of the metal carboxylate compound.

In more preferred embodiments, the group 4 to 6 metal is niobium, preferably wherein u=w=0, v is 1 or more (preferably 2), x is 1 or more (preferably 1), y is 1 or more (preferably 2), and/or (preferably and) z is 1; most preferably wherein [counterion]_{z} represents one counterion having a charge of +1, preferably NH₄⁺.

In alternative preferred embodiments, the group 4 to 6 metal is niobium, preferably u is 1 or more (preferably 5), v=w=0, x is 0, y is 0, and/or (preferably and) z is 0.

Most preferred carboxylate ligands include monodentate oxalate ligand(s) and/or (preferably or) bidentate oxalate ligand(s).

In most preferred embodiments, the metal carboxylate is a metal oxalate or an ammonium metal oxalate, preferably an ammonium metal oxalate.

Herein, a “metal oxalate” is a metal carboxylate comprising one or more oxalate ligand (as the carboxylate ligand). In preferred embodiments, the metal oxalate comprises:
one or more oxalate ligand as the carboxylate ligand (preferably the oxalate ligand is a monodentate oxalate ligand, i.e., u is 1 or more; and preferably v=w=0);
no counterion (z is 0); and/or (preferably and)
no other ligand (x=y=0).
   A most preferred metal oxalate is niobium (V) hydrogen oxalate:

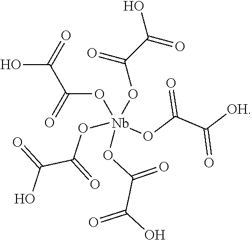

Herein, an “ammonium metal oxalate” is a metal carboxylate comprising at least one monodentate oxalate ligand (as U, with u being 1 or more) or bidentate oxalate ligand (as V, with v being 1 or more) as the carboxylate ligand and one or more ammonium counterion (i.e., [counterion] is NH₄⁺ and z is 1 or more). In preferred embodiments, the ammonium metal oxalate comprises:
one or more bidentate oxalate ligands as the carboxylate ligand, i.e., V is a bidentate oxalate ligand and v is 1 or more (preferably 2),
u=w=0, and
one or more other ligand, preferably one or more ═O (x is 1 or more) and/or one or more water molecules (y is 1 or more), preferably both.
   A most preferred ammonium metal oxalate is ammonium niobium oxalate, which is:

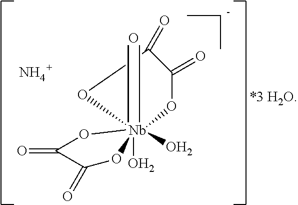

In the invention, the metal carboxylate, such as the ammonium metal oxalate, may be in hydrated form or in non-hydrated form.

Herein, a “chalcogen” is a chemical element of group 16 of the periodic table according to the modern IUPAC notation and a “chalcogenide” is a compound comprising a chalcogen atom. Preferred chalcogenides comprise at least one S, Se, or Te atom. Most preferred chalcogenides comprise at least one S atom.

In preferred embodiments, an organochalcogenide is used.

“Organochalcogenides” are compounds comprising at least one chemical bond between a carbon atom of an organic group and a chalcogen atom. Preferred chalcogen in organochalcogenides include S, Se, and Te, more preferably S. Thus, the most preferred organochalcogenides are organosulfurs, such as thiophene, thiols, thiolanes, polysulfides, and thiazole.

Preferred organic groups in organochalcogenides include amino, carboxylate, carbonyl, and alkyl. The most preferred organic groups for organochalcogenides are amino and carbonyl.

A most preferred organochalcogenide is thiourea.

In more preferred embodiments, the method comprises:
reacting the metal carboxylate with hydrogen peroxide and citric acid to form a soluble peroxo-citrato-metal complex, and
then reacting the peroxo-citrato-metal complex with the chalcogenide or the organochalcogenide, thereby producing the metal compound.

This method of manufacture typically produces a colloidal suspension of particles of the metal compound.

In embodiments, the metal compound comprises niobium (Nb), sulfur(S), oxygen (O), nitrogen (N), and carbon (C).

In embodiments, the metal compound consists of niobium (Nb), sulfur(S), oxygen (O), nitrogen (N), and carbon (C).

In embodiments, the metal compound has a Raman spectrum comprising bands at about 84, about 152, about 218, about 246, about 438, and about 474 cm⁻¹. In embodiments, the Raman spectrum is as shown in FIG. 25.

In embodiments, the metal compound can be supported on a support. When the support is conducting, the electrode of the invention is obtained.

### the Metal Recovery Electrode & its Method of Manufacture

As noted previously, the metal recovery electrode comprises the above metal compound on a conducting support.

The support can be any conducting support. Non limiting examples of support include
carbon-based supports, such as carbon-fiber paper, carbon cloth, carbon foams, and carbon felt;
carbon materials, such as:
   carbon black,
   porous carbon materials, fullerenes, carbon nanotubes, carbon fibers, carbon filaments, carbon xerogel, carbon aerogel, nanocage carbons, carbon nanohorns, carbon nano-onions, carbon nano-capsules, and their graphitic forms,
   graphene-type materials, such as monolayer graphene, few layers graphene materials, reduced graphene oxide, and graphene oxide,
   heteroatom-doped carbon materials and heteroatom-doped graphene-type materials, wherein the heteroatom is preferably N, S, or P, and
   carbon nitride and graphitic carbon nitride; and
meshes, foams, felts and porous transport layers from sintered nanoparticles of:
   one or more of Cu, Zn, Sb, Ag, Au, Pt, and Ru
   transition metal carbides, wherein the transition metal is preferably Ti, V, Cr, Zr, Nb, Mo, Hf, Ta, W, or Fe,
   transition metal nitrides, wherein the transition metal is preferably Ti, V, Cr, Zr, Nb, Mo, Hf, Ta, W, Mn, Ni, Co, Fe, Cu; and
   conductive transition metal oxides, such as RuO₂ and IrO₂.

In preferred embodiments, the conducting support is carbon fiber paper.

The metal compound can be deposited on the conducting support using standard deposition methods.

In preferred embodiments, the metal recovery electrode is made by electrodepositing the metal compound on the conducting support. The present invention thus also provides a method of manufacturing the electrode comprising: electrodepositing the metal compound on the conducting support.

In embodiments, the electrodepositing comprises using the conducting support as a working electrode, using a counter-electrode, and using an aqueous suspension of particles of the metal compound as an electrolyte between the working electrode and the counter-electrode.

Preferred counter-electrode includes carbon rod, carbon fiber paper, and graphite plate. A most preferred counter-electrode is carbon fiber paper.

A reference electrode, such as Ag/AgCl, can also be used for the electrodeposition.

### Uses and Method of Use of the Metal Compound and the Metal Recovery Electrode

As noted above, there is also provided the use of the metal compound for the electrochemical recovery of a metal from a spent electrode as well as the use of the metal recovery electrode for the electrochemical recovery of a metal from a spent electrode. Also, there is provided a method for the electrochemical recovery of a metal from a spent electrode, the method comprising the steps of:
a) providing an electrochemical cell comprising the metal recovery electrode as a working electrode, the spent electrode as a counter-electrode, and an electrolyte between the working electrode and the counter-electrode, and
b) applying a potential or a current between the working electrode and the counter-electrode to dissolve the metal from the spent electrode and electrodeposit dissolved atoms of the metal on the working electrode, thereby recovering the metal and forming a composite electrode.

Indeed, the abundant chalcogen-containing sites (e.g., sulfur-containing sites) in the metal recovery electrode can trap the metal to be recovered.

A reference electrode, such as Ag/AgCl, can also be used for step b).

The metal to be recovered from the spent electrode can be any noble metal, such as Pt, Pd, Ir, Au, and Ag, as well as Ni and Cu. Indeed, these have an affinity to binding organosulfur compounds, organochalcogenides, and sulfides. In preferred embodiments, the metal to be recovered is Pt.

The spent electrode can be for example end-of-life electrodes from membrane electrode assemblies of proton exchange membrane fuel cells, from electrolyzers, from metal-air batteries, from reversible fuel cells, from water splitting devices, or from solar energy conversion devices.

In embodiments, the method further comprises the step c) of using the composite electrode as a gas diffusion electrode, preferably for hydrogen evolution.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Herein, the term “radical” means a subunit of a larger molecule. A monovalent radical is attached to this larger molecule via a single bond, a bivalent radical is attached to the larger molecule via two bonds, and a trivalent radical is attached to the larger molecule via three bonds.

Herein, the terms “alkyl”, “alkylene”, “alkylidyne” and their derivatives have their ordinary meaning in the art. For more certainty, herein:

| | |
|---|---|
| Term | Definition |

Saturated aliphatic hydrocarbons

| | |
|---|---|
| alkane | aliphatic hydrocarbon of general formula CₙH₂ₙ₊₂ |
| alkyl | monovalent alkane radical of general formula —CₙH₂ₙ₊₁ |
| alkylene | bivalent alkane radical of general formula —CₙH₂ₙ— |
| (also called | |
| alkanediyl) | |
| alkylidyne | trivalent alkane radical of general formula —CₙH₂ₙ₋₁— |

Aliphatic hydrocarbons with double bond(s)

| | |
|---|---|
| alkene | aliphatic hydrocarbon, similar to an alkane but comprising at least one double bond |
| alkenyl | monovalent alkene radical, similar to an alkyl but comprising at least one double bond |
| alkenylene | bivalent alkene radical, similar to an alkylene but comprising at least one double bond |
| alkenylidyne | trivalent alkene radical, similar to an alkylidyne but comprising at least one double bond |

Aliphatic hydrocarbons with triple bond(s)

| | |
|---|---|
| alkyne | aliphatic hydrocarbon, similar to an alkane but comprising at least one triple bond |
| alkynyl | monovalent alkyne radical, similar to an alkyl but comprising at least one triple bond |
| alkynylene | bivalent alkyne radical, similar to an alkylene but comprising at least one triple bond |
| alkynylidyne | trivalent alkyne radical, similar to an alkylidyne but comprising at least one triple bond |

Aliphatic hydrocarbons with double and triple bonds

| | |
|---|---|
| alkenyne | aliphatic hydrocarbon, similar to an alkane but comprising at least one double bond and at |
| | least one triple bond |
| alkenynyl | monovalent alkenyne radical, similar to an alkyl but comprising at least one double bond and |
| | at least one triple bond |
| alkenynylene | bivalent alkenyne radical, similar to an alkylene but comprising at least one double bond and at |
| | least one triple bond |
| alkenynylidyne | trivalent alkenyne radical, similar to an alkylidyne but comprising at least one double bond and |
| | at least one triple bond |

It is to be noted that, unless otherwise specified, the hydrocarbon chains of the above groups can be linear or branched. Further, unless otherwise specified, these groups can contain between 1 and 18 carbon atoms, more specifically between 1 and 12 carbon atoms, between 1 and 6 carbon atoms, between 1 and 3 carbon atoms.

Herein, a “group interrupted with one or more A, B, and/or C” means that one or more A, B, and/or C groups are inserted between pairs adjacent carbon atoms of the group (for example, a butylene group (—CH₂—CH₂—CH₂—CH₂—) interrupted by —O— may be —CH₂—CH₂—O—CH₂—CH₂—. Preferably, only one of A, B or C is inserted between any given pair of adjacent carbon atoms. However, when more than one pairs of adjacent carbon atoms are thus interrupted, the A, B, and C groups do not need to be identical: for example, one hydrogen atom may be replaced by A, while another may be replaced by B (for example a butylene group (—CH₂—CH₂—CH₂—CH₂—) interrupted by —O— and —NR— may be —CH₂—NR—CH₂—O—CH₂—CH₂—.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The groups of the periodic table are identified herein using the modern IUPAC convention (which uses Arabic numerals from 1 to 18).

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—Preparation and Characterization of a Self-supported Earth Abundant Catalyst and Electrode

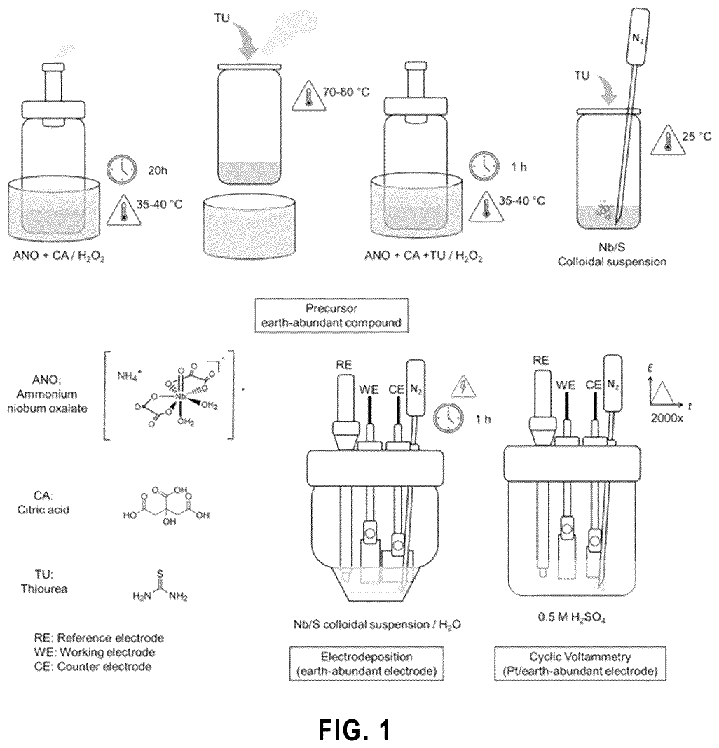

As included in FIG. 1, a precursor solution was prepared in a glass reactor coupled with a degassing valve. 2.39 g ammonium niobium oxalate (CBMM, 23.1% Nb) were mixed with 17.6 mL hydrogen peroxide (H₂O₂, Thermo Scientific, 30%), and stirred for 3 min before adding 1.04 g of citric acid (Fisher Scientific, 99.6%). The bright yellow solution was kept in an oil bath at 50° C. and magnetically stirred for 20 h; the temperature of the solution was maintained at 35-40° C. Subsequently, the solution was removed from the oil bath, and 1.04 g thiourea (Thermo® Scientific, 99%) were added slowly to control the highly exothermic reaction; the solution temperature increased to 70-80° C. The glass reactor was kept in the oil bath at 50° C., and the lighter yellow solution was stirred for another hour. Finally, the solution was cooled down to 35° C. and stirred and bubbled with nitrogen gas while 0.72 g thiourea were further added and stirred for 30 min, resulting in a yellow/whiteish colloidal suspension.

The earth-abundant compound was electrodeposited into carbon fiber paper (CFP, Spectracarb® 2050A-0850), previously cut (30×15 mm²), ultrasonically cleaned in acetone for 15 min, and oxidized in a furnace at 500° C. for 2 hours. The electrodeposition was performed in a three-electrode cell configuration; CFP was used as the working electrode, a saturated Ag/AgCl as the reference electrode, and a Pt plate as the counter-electrode. The precursor colloidal suspension (8 mL) was mixed with deionized water to reach a 20 mL volume and magnetically stirred and bubbled with nitrogen during electrodeposition. A Teflon/Pt contact electrode was used to hold the CFP substrate and maintained at 1 cm below the solution level. A 20 mA cm⁻² was applied in galvanostatic mode for 1 hour. Then, the sample was washed with distilled water and dried under ambient conditions before using it for the PGM recovery.

### Characterization by SEM/EDS

Scanning electron microscopy (SEM) was carried out using a Tescan Vega3 LMH scanning electron microscope equipped with a Quantax energy dispersive X-ray (EDX) detector.

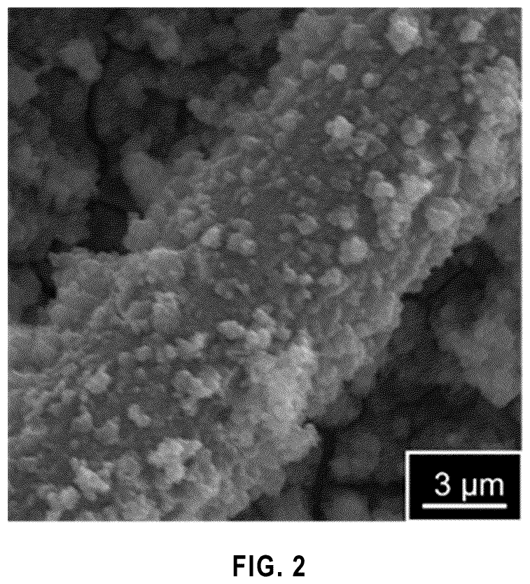

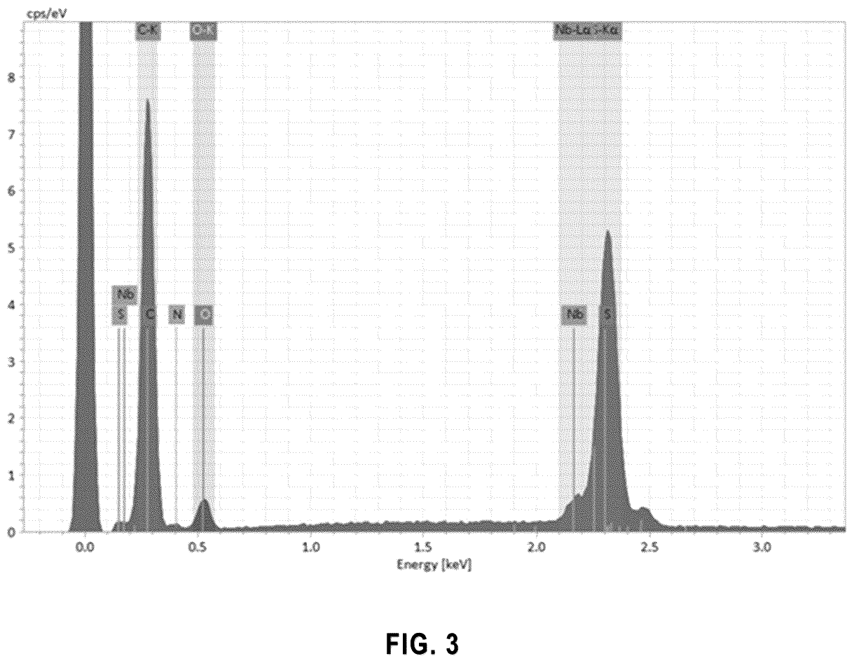

The morphology of the self-supported earth-abundant compound was characterized by SEM, shown in FIG. 2. The electrodeposition allows for the homogeneous growth of the earth-abundant compound onto the CFP with morphologies that can be further tuned by adjusting the electrodeposition parameters. FIG. 3 exhibits the EDS spectrum which confirms the presence of the constituent elements, including niobium (Nb), sulfur(S), oxygen (O), nitrogen (N), and carbon (C). No other elements were found.

### Characterization by X-Ray Photoelectron Spectroscopy

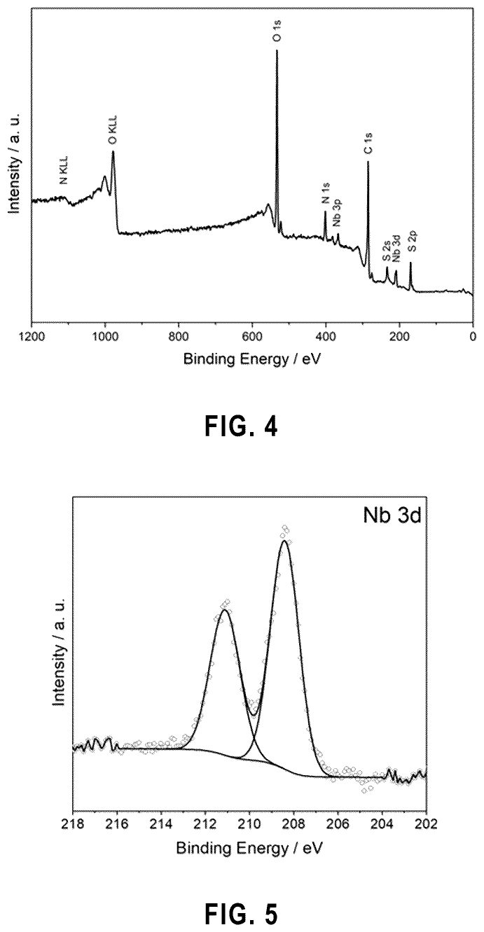

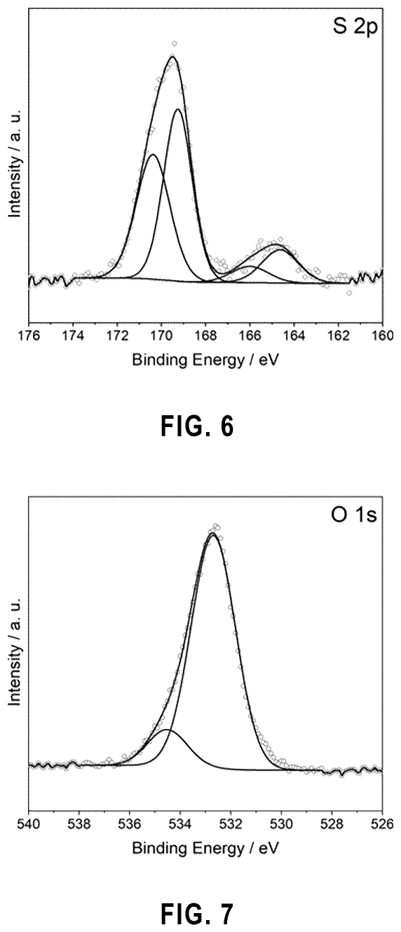

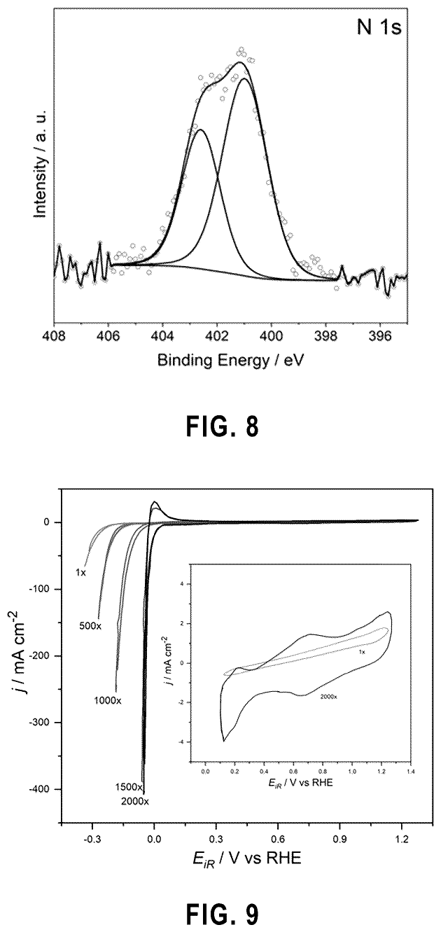

X-ray photoelectron spectroscopy (XPS) was performed in a VG Escalab 220i-XL equipped with a twin anode X-ray source. All the spectra were corrected to give the adventitious C 1s spectral component a binding energy of 284.8 eV. XPS analysis was performed to obtain information about the surface chemical composition of the earth-abundant compound electrode. The survey spectrum in FIG. 4 confirms the presence of previously identified elements (Nb, S, O, N, and C). FIG. 5 exhibits the high-resolution Nb 3d spectrum where the two components at 208.4 (Nb 3d_{5/2}) and 211.1 eV (Nb 3d_{3/2}) are related to Nb(V).²⁷ The S 2p region is shown in FIG. 6 where the peaks located at 164.6 and 166.0 eV are related to heterocyclic sulfur^{28, 29} and the peaks at 169.3, and 170.4 eV are related to the oxidized sulfur species. FIG. 7 shows the O 1s peak, which was deconvoluted into two components at 532.7 eV related to the oxidized sulfur and carbon species (C—O, C═O)²⁹ and another at 534.5 eV chemisorbed water. Lastly, FIG. 8 shows N 1s core-level spectrum with two components at 401.1 and 402.6 eV related to quaternary and oxidized N species, respectively.

### Characterization by Raman Spectroscopy

The Raman spectrum included in FIG. 25 shows a zoom in highlighting the Raman bands corresponding to the earth-abundant compound at 84 cm⁻¹ assigned to the S inter-ring stretching, the band at 152 cm⁻¹ attributed to the Nb—Nb vibrational mode, along with the characteristic band of the Nb—O—Nb bending modes^{2.10}. Moreover, the bands at 246, 438 and 474 cm⁻¹, correspond to the Nb—S, S-interring (and SO₄) and the C—S—C stretching modes, respectively.^{2.4, 2.11, 2.12} The bands around 1350 and 1585 cm⁻¹ are attributed to D and G bands of the carbon support.

### Example 2—Electrochemical Recycling/Upcycling of Platinum from a Planar Electrode Using the Electrode of Example 1

### Progressive Platinum Loading

The PGM recovery from a planar electrode was conducted in a three-electrode cell, using the above-mentioned self-supported earth-abundant compound/CFP as working electrode, a saturated Ag/AgCl as reference electrode, and a Pt plate as the counter-electrode. The surface of the flat Pt counter electrode was reduced/oxidized by performing cyclic voltammetry on the earth-abundant electrode produced in Example 1 in 0.5 M H₂SO₄, using a Solartron® SI 1287 Potentiostat/Galvanostat, in the potential window range of −0.7 V to 1 V. The working electrode was cycled 2 000 times using a scan rate of 100 mV s⁻¹ as included in FIG. 9. During the first cycle towards the cathodic direction in the working electrode, the surface of the Pt counter electrode is oxidized. Subsequently, this Pt oxide layer is reduced and exposes the Pt metal surface. The exposed Pt metal dissolves into the H₂SO₄ electrolyte. The dissolved Pt species migrate to the working electrode, where the earth-abundant catalyst traps them due to its abundant sulfur-containing sites. The newly upcycled Pt particles can be observed in the CV included in the inset (FIG. 9), which compares the initial earth-abundant electrode with no redox peaks and the final composite electrode comprising the typical Pt redox processes in this potential window range.

### Characterization by SEM/EDS

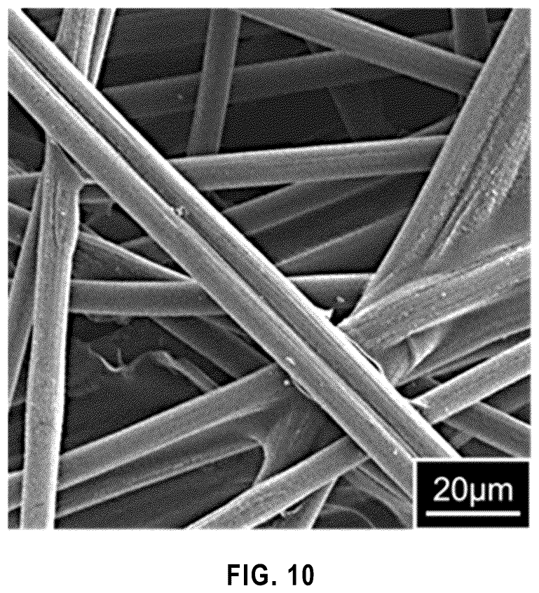

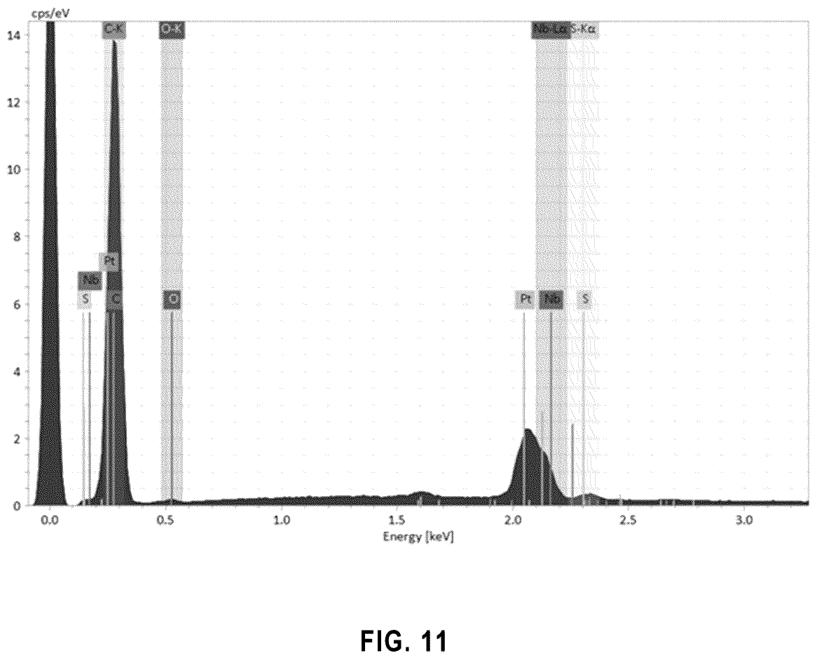

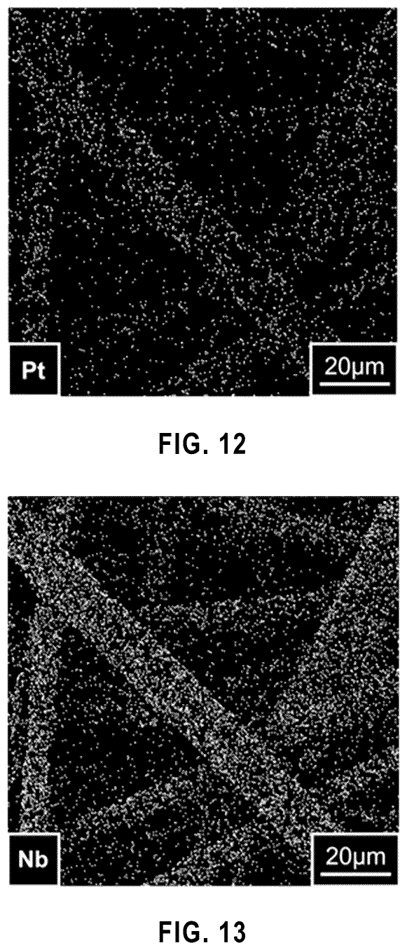

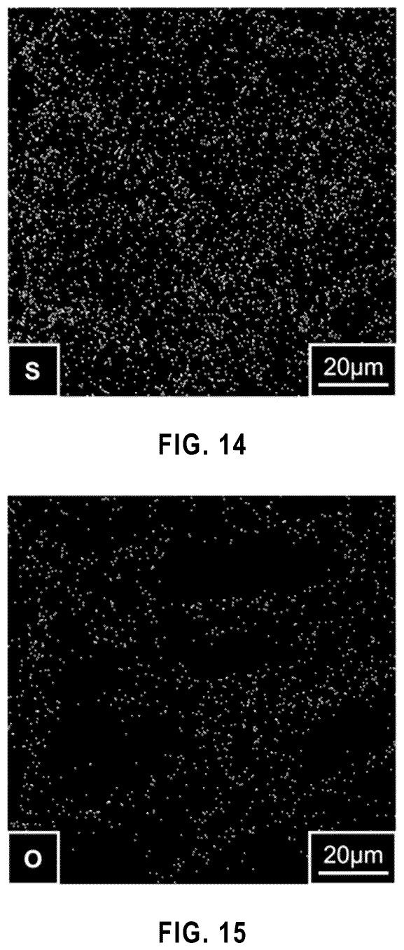

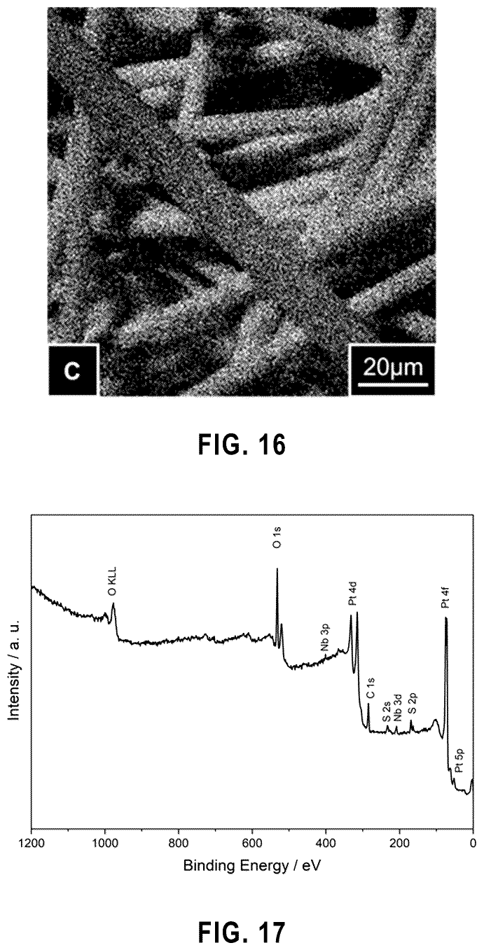

FIG. 10 exhibits a low magnification SEM image showing the Pt/earth-abundant catalyst homogenously deposited onto the carbon fibers from the substrate. The EDS spectrum shown in FIG. 11 confirms the presence of all the elements including Pt, Nb, S, O, and C. The EDS mapping included in FIGS. 12, 13, 14, 15 and 16 corroborates the homogeneous dispersion of all elements, i.e., Pt, Nb, S, and O, onto the C, respectively, from the CFP substrate.

### Characterization by XPS

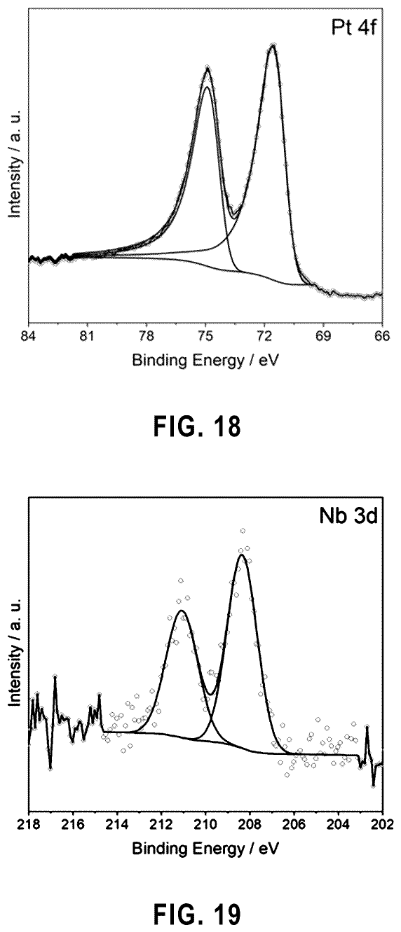

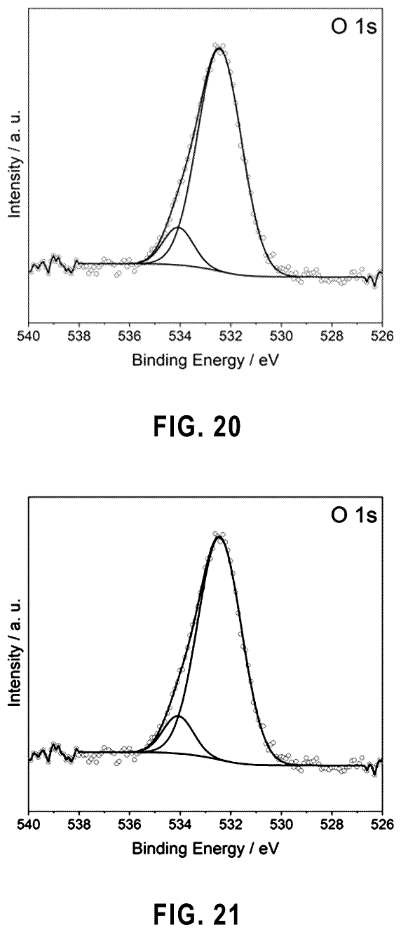

The survey spectrum in FIG. 17 confirms the above-identified elements (Nb, S, O, N, and C). The high-resolution Pt 4f spectrum shown in FIG. 18 consists of a pair of doublets, located at 71.5 and 74.9 eV, assigned to the metallic Pt species.³⁰ The Nb 3d spectrum in FIG. 19 displays the previously identified components at the same position, i.e., 208.4 and 211.1 eV related to Nb(V). The S 2p spectrum shown in FIG. 20 exhibits a shift of two components to lower binding energies, where the 162.8 and 164.0 eV peaks are associated with the thiolate species bound to the metal surface^{31, 32} and the peaks at 169.1 and 170.2 eV are related to the oxidized sulfur species. As previously found, the O 1s in FIG. 21 displays two components at 532.4 eV and 534.1 eV, related to the oxidized sulfur and carbon species (C—O, C═O) for the former and to the chemisorbed water for the latter. The absence of N in the composite electrode indicates that the occurrence in the as-prepared earth-abundant catalyst was due to impurities of the thiourea precursor.

### Characterization by Raman Spectroscopy

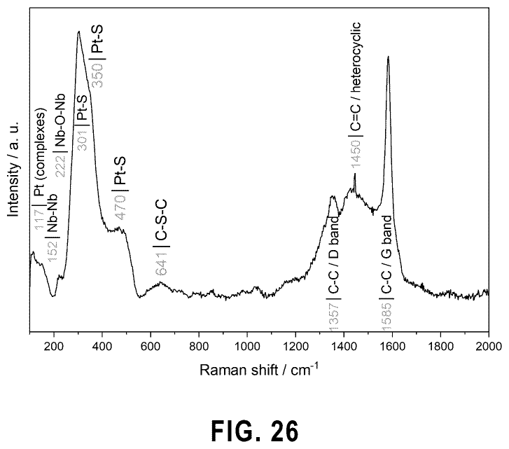

The spectrum displayed in FIG. 26 shows the same Raman bands attributed to the earth-abundant compound, the Nb—Nb and Nb—O—Nb vibrational modes located at 152 and 222 cm 1, respectively. Additionally, the Raman active bands assigned to the Pt in complexes at 117 cm⁻¹ and the ones related to the Pt—S bonding are located at 301, 350 and 470 cm⁻¹. Moreover, the bands at 641 and 1450 cm⁻¹ are attributed to the C—S—C and the C═C (heterocyclic) stretching modes. The bands around 1350 and 1585 cm⁻¹ are related to D and G bands of the carbon support.

### Performance of the Composite Electrode Towards the Hydrogen Evolution Reaction

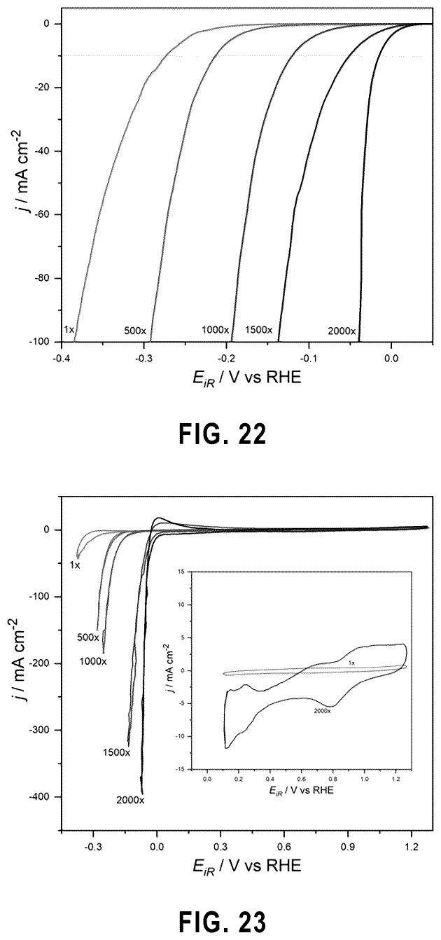

The polarization curves included in FIG. 22 were obtained after each series of cyclic voltammograms (1×, 500×, 1000×, 1500×, and 2000×). The curves reported correspond to the third linear scan sweep from 0.5 to −0.7V vs Ag/AgCl at a scan rate of 10 mV s⁻¹. The overpotential needed to achieve a benchmark cathodic current density of 10 mA cm 2 is reduced significantly from −272 mV (1^{st} cycle) to −15 mV (2000^{th} cycle), due to the increase of the Pt content in the resulting earth-abundant composite electrode.

### Example 3—Electrochemical Recycling/Upcycling of Platinum from a Gas Diffusion Electrode Using the Electrode of Example 1

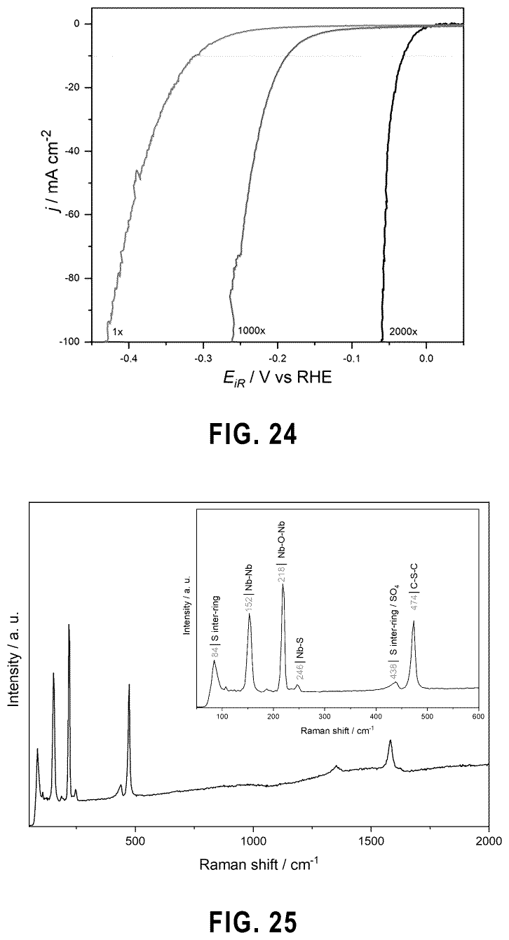

The PGM recovery from a gas diffusion electrode was conducted in a three-electrode cell configuration. The self-supported earth-abundant catalyst/CFP was used as working electrode, a saturated Ag/AgCl as reference electrode, and a Pt/C gas diffusion electrode (Carbon cloth, 60 wt % Pt/C, 3 mg Pt/cm²) as counter-electrode. As previously described, cyclic voltammetry was performed on the earth-abundant electrode in 0.5 M H₂SO₄, using a Solartron® SI 1287 Potentiostat/Galvanostat, in the potential window range of −0.7 V to 1 V. FIG. 23 displays the cycle voltammograms obtained at 1×, 500×, 1000×, 1500× and 2000× cycles using a scan rate of 100 mV s⁻¹. The inset in this figure, compares the initial stage of the earth-abundant electrode with no redox peaks and the final state of the composite electrode comprising the typical Pt redox processes in this potential window range. As previously demonstrated and as included in FIG. 24, the progressive Pt loading in the earth-abundant electrode contributes to a remarkable decrease in the overpotential needed to drive the hydrogen evolution reaction, requiring an overpotential <30 mV to achieve a cathodic current density of 10 mA cm⁻². This remarkable performance indicates the feasibility of using a direct electrochemical approach to recycle and upcycle these critical materials and obtain a composite electrode including earth-abundant elements.

The scope of the claims should not be limited by the preferred embodiments set forth in the examples but should be given the broadest interpretation consistent with the description as a whole.

### REFERENCES

The present description refers to a number of documents, the content of which is herein incorporated by reference in their entirety. These documents include, but are not limited to, the following:
1. Reck, B. K.; Graedel, T. E., Challenges in metal recycling. Science 2012, 337 (6095), 690-695.
2. Harper, G.; Sommerville, R.; Kendrick, E.; Driscoll, L.; Slater, P.; Stolkin, R.; Walton, A.; Christensen, P.; Heidrich, O.; Lambert, S., Recycling lithium-ion batteries from electric vehicles. nature 2019, 575 (7781), 75-86.
3. Mrozik, W.; Rajaeifar, M. A.; Heidrich, O.; Christensen, P., Environmental impacts, pollution sources and pathways of spent lithium-ion batteries. Energy & Environmental Science 2021, 14 (12), 6099-6121.
4. Koehler, J. Z., Ralf; Binder, Matthias; Baenisch, Volker; Lopez, Marco Process for recycling fuel cell components containing precious metals. 2008.
5. Paepke, M. Method for recycling membrane/electrode units of a fuel cell. 2015.
6. Mountain, B. W.; Wood, S. A., Solubility and transport of platinum-group elements in hydrothermal solutions: thermodynamic and physical chemical constraints. In Geo-platinum 87, Springer: 1988; pp 57-82.
7. Vincent, R. C., Raphael; Dubau, Laetitia, Duclos, Lucken, Svecova, Lenk, Thivel, Pierre-Xavier WO2018/138427A1 2018.
8. Granados-Fernández, R.; Montiel, M. A.; Diaz-Abad, S.; Rodrigo, M. A.; Lobato, J., Platinum Recovery Techniques for a Circular Economy. Catalysts 2021, 11 (8), 937.
9. Andersen, S. M. S., Raghunandan Method for dissolving precious metals. 2019.
10. Eifert, A. B., Claudio Method for obtaining platinum and/or ruthenium. 2021.
11. Furuya, Y.; Mashio, T.; Ohma, A.; Tian, M.; Kaveh, F.; Beauchemin, D.; Jerkiewicz, G., Influence of electrolyte composition and pH on platinum electrochemical and/or chemical dissolution in aqueous acidic media. Acs Catalysis 2015, 5 (4), 2605-2614.
12. Chia, X.; Eng, A. Y. S.; Ambrosi, A.; Tan, S. M.; Pumera, M., Electrochemistry of nanostructured layered transition-metal dichalcogenides. Chemical reviews 2015, 115 (21), 11941-11966.
13. Yang, J.; Mohmad, A. R.; Wang, Y.; Fullon, R.; Song, X.; Zhao, F.; Bozkurt, I.; Augustin, M.; Santos, E. J.; Shin, H. S., Ultrahigh-current-density niobium disulfide catalysts for hydrogen evolution. Nature materials 2019, 18 (12), 1309-1314.
14. Liu, Y.; Wu, J.; Hackenberg, K. P.; Zhang, J.; Wang, Y. M.; Yang, Y.; Keyshar, K.; Gu, J.; Ogitsu, T.; Vajtai, R., Self-optimizing, highly surface-active layered metal dichalcogenide catalysts for hydrogen evolution. Nature Energy 2017, 2 (9), 1-7.
15. Zhang, J.; Wu, J.; Zou, X.; Hackenberg, K.; Zhou, W.; Chen, W.; Yuan, J.; Keyshar, K.; Gupta, G.; Mohite, A., Discovering superior basal plane active two-dimensional catalysts for hydrogen evolution. Materials Today 2019, 25, 28-34.
16. Nowak, I.; Ziolek, M., Niobium compounds: preparation, characterization, and application in heterogeneous catalysis. Chemical Reviews 1999, 99 (12), 3603-3624.
17. Bayot, D.; Tinant, B.; Devillers, M., Water-soluble niobium peroxo complexes as precursors for the preparation of Nb-based oxide catalysts. Catalysis today 2003, 78 (1-4), 439-447.
18. Rani, R. A.; Zoolfakar, A. S.; O'Mullane, A. P.; Austin, M. W.; Kalantar-Zadeh, K., Thin films and nanostructures of niobium pentoxide: fundamental properties, synthesis methods and applications. Journal of Materials Chemistry A 2014, 2 (38), 15683-15703.
19. Si, J.; Zheng, Q.; Chen, H.; Lei, C.; Suo, Y.; Yang, B.; Zhang, Z.; Li, Z.; Lei, L.; Hou, Y., Scalable production of few-layer niobium disulfide nanosheets via electrochemical exfoliation for energy-efficient hydrogen evolution reaction. ACS applied materials & interfaces 2019, 11 (14), 13205-13213.
20. Najafi, L.; Bellani, S.; Oropesa-Nuñez, R.; Martín-García, B.; Prato, M.; Mazánek, V.; Debellis, D.; Lauciello, S.; Brescia, R.; Sofer, Z., Niobium disulphide (NbS 2)-based (heterogeneous) electrocatalysts for an efficient hydrogen evolution reaction. Journal of Materials Chemistry A 2019, 7 (44), 25593-25608.
21. Jha, G.; Tran, T.; Qiao, S.; Ziegler, J. M.; Ogata, A. F.; Dai, S.; Xu, M.; Le Thai, M.; Chandran, G. T.; Pan, X., Electrophoretic deposition of mesoporous Niobium (V) oxide nanoscopic films. Chemistry of Materials 2018, 30 (18), 6549-6558.
22. RobertaLee, G., Studies on the electrochemical deposition of niobium oxide. Journal of Materials Chemistry 1996, 6 (2), 187-192.
23. Zhitomirsky, I., Electrolytic deposition of niobium oxide films. Materials Letters 1998, 35 (3-4), 188-193.
24. Saez Cabezas, C. A.; Miller, K.; Heo, S.; Dolocan, A.; LeBlanc, G.; Milliron, D. J., Direct Electrochemical Deposition of Transparent Metal Oxide Thin Films from Polyoxometalates. Chemistry of Materials 2020, 32 (11), 4600-4608.
25. Narendar, Y.; Messing, G. L., Synthesis, decomposition and crystallization characteristics of peroxo-citrato-niobium: an aqueous niobium precursor. Chemistry of materials 1997, 9 (2), 580-587.
26. Tang, K.; Wang, X.; Li, Q.; Yan, C., High Edge Selectivity of In Situ Electrochemical Pt Deposition on Edge-Rich Layered WS2 Nanosheets. Advanced Materials 2018, 30 (7), 1704779.
27. Koito, Y.; Rees, G. J.; Hanna, J. V.; Li, M. M.; Peng, Y. K.; Puchtler, T.; Taylor, R.; Wang, T.; Kobayashi, H.; Teixeira, I. F., Structure-Activity Correlations for Brønsted Acid, Lewis Acid, and Photocatalyzed Reactions of Exfoliated Crystalline Niobium Oxides. ChemCatChem 2017, 9 (1), 144-154.
28. Noh, J.; Ito, E.; Nakajima, K.; Kim, J.; Lee, H.; Hara, M., High-resolution STM and XPS studies of thiophene self-assembled monolayers on Au (111). The Journal of Physical Chemistry B 2002, 106 (29), 7139-7141.
29. Manceau, M.; Gaume, J.; Rivaton, A.; Gardette, J.-L.; Monier, G.; Bideux, L., Further insights into the photodegradation of poly (3-hexylthiophene) by means of X-ray photoelectron spectroscopy. Thin Solid Films 2010, 518 (23), 7113-7118.
30. Vovk, E. I.; Kalinkin, A. V.; Smirnov, M. Y.; Klembovskii, I. O.; Bukhtiyarov, V. I., XPS study of stability and reactivity of oxidized Pt nanoparticles supported on TiO2. The Journal of Physical Chemistry C 2017, 121 (32), 17297-17304.
31. Buckel, F.; Effenberger, F.; Yan, C.; Gölzhäuser, A.; Grunze, M., Influence of aromatic groups incorporated in long-chain alkanethiol self-assembled monolayers on gold. Advanced Materials 2000, 12 (12), 901-905.
32. Laiho, T.; Leiro, J.; Lukkari, J., XPS study of irradiation damage and different metal-sulfur bonds in dodecanethiol monolayers on gold and platinum surfaces. Applied surface science 2003, 212, 525-529.
2.1. L. Najafi, S. Bellani, R. Oropesa-Nuñez, B. Martín-García, M. Prato, V. Mazánek, D. Debellis, S. Lauciello, R. Brescia and Z. Sofer, Journal of Materials Chemistry A, 2019, 7, 25593-25608.
2.2. K. Tang, X. Wang, Q. Li and C. Yan, Advanced Materials, 2018, 30, 1704779.
2.3. V. K. Jain and L. Jain, Coordination Chemistry Reviews, 2005, 249, 3075-3197.
2.4. B. R. Moraes, N. S. Campos and C. M. Izumi, Vibrational Spectroscopy, 2018, 96, 137-142.
2.5. A. Singhal, V. K. Jain, B. Varghese and E. R. Tiekink, Inorganica chimica acta, 1999, 285, 190-196.
2.6. L. Najafi, S. Bellani, R. Oropesa-Nuñez, R. Brescia, M. Prato, L. Pasquale, C. Demirci, F. Drago, B. Martín-García and J. Luxa, Small, 2020, 16, 2003372.
2.7. J. Cui and L. Zhang, Journal of hazardous materials, 2008, 158, 228-256.
2.8. J. Noh, E. Ito, K. Nakajima, J. Kim, H. Lee and M. Hara, The Journal of Physical Chemistry B, 2002, 106, 7139-7141.
2.9. M. Manceau, J. Gaume, A. Rivaton, J.-L. Gardette, G. Monier and L. Bideux, Thin Solid Films, 2010, 518, 7113-7118.
2.10. J. A. Oliveira, M. O. Reis, M. S. Pires, L. A. Ruotolo, T. C. Ramalho, C. R. Oliveira, L. C. Lacerda and F. G. Nogueira, Materials Chemistry and Physics, 2019, 228, 160-167.
2.11. M. Hangyo, K. Kisoda, T. Nishio, S. Nakashima, T. Terashima and N. Kojima, Physical Review B, 1994, 50, 12033.
2.12. R. L. Frost, J. T. Kloprogge and W. N. Martens, Journal of Raman Spectroscopy, 2004, 35, 28-35.

1. A method of manufacture of a metal compound, the method comprising:
reacting a metal carboxylate, wherein the metal is a group 4 to 6 metal,
with
a chalcogenide or an organochalcogenide.

2. The method of claim 1, wherein the organochalcogenide is an organosulfur.

3. The method of claim 1, wherein the organochalcogenide comprises an amino, carboxylate, carbonyl, or alkyl group.

4. The method of claim 1, wherein the organochalcogenide is thiourea.

5. The method of claim 1, wherein the group 4 to 6 metal is Ti, Zr, Nb, Ta, Hf, Mo, or W.

6. The method of claim 1, wherein the metal carboxylate is a compound comprising the group 4 to 6 metal coordinated with one or more carboxylate ligand, optionally one or more other ligands, and optionally one or more counterions.

7. The method of claim 6, wherein the carboxylate ligand is a monodentate carboxylate ligand of formula (I): 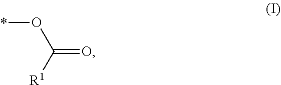
wherein R¹ is a hydrogen atom or a monovalent organic radical.

8. The method of claim 6, wherein the carboxylate ligand is a bidentate carboxylate ligand of formula (II): 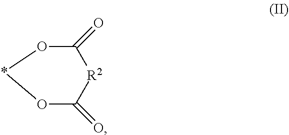
wherein R² is a covalent bond or a bivalent organic radical.

9. The method of claim 6, wherein the carboxylate ligand is a tridentate carboxylate ligand of formula (III): 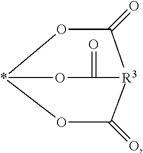
wherein R³ is a trivalent organic radical.

10. The method of claim 1, wherein the metal carboxylate is of formula (IV): 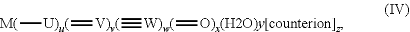
wherein
M is the group 4 to 6 metal,
U is a monodentate carboxylate ligand as defined above,
V is a bidentate carboxylate ligand as defined above,
W is a tridentate carboxylate ligand as defined above,
u is 0 or more,
v is 0 or more,
w is 0 or more,
x is 0 or more,
y is 0 or more, and
z is 0 or more,
with the proviso that at least one of u, v, and w is 1 or more.

11. The method of claim 1, wherein the metal oxalate is niobium (V) hydrogen oxalate:

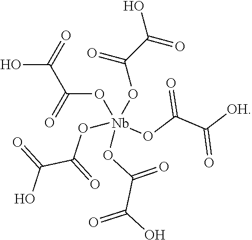

12. The method of claim 1, wherein the metal carboxylate is an ammonium metal oxalate, and wherein the ammonium metal oxalate is ammonium niobium oxalate, which is:

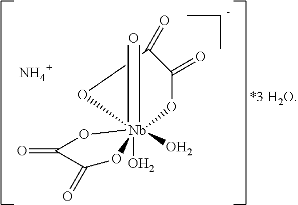

13. The method of claim 1, wherein comprising:
reacting the metal carboxylate with hydrogen peroxide and citric acid to form a soluble peroxo-citrato-metal complex, and
then reacting the peroxo-citrato-metal complex with the chalcogenide or the organochalcogenide, thereby producing the metal compound.

14. A metal compound made by the method of claim 1.

15. The metal compound of claim 14, consisting of niobium (Nb), sulfur(S), oxygen (O), nitrogen (N), and carbon (C).

16. The metal compound of claim 14, having a Raman spectrum comprising bands at about 84, about 152, about 218, about 246, about 438, and about 474 cm⁻¹; preferably having a Raman spectrum is as shown in FIG. 25.

17. A metal recovery electrode comprising the metal compound of claim 14 on a conducting support.

18. A method for manufacturing the metal recovery electrode of claim 17, the method comprising depositing the metal compound on the conducting support.

19. The method of claim 18, comprising electrodepositing the metal compound on the conducting support, wherein the electrodepositing comprises using the conducting support as a working electrode, using a counter-electrode, and using an aqueous suspension of particles of the metal compound as an electrolyte between the working electrode and the counter-electrode.

20. A method for the electrochemical recovery of a metal from a spent electrode, the method comprising the steps of:
A) providing an electrochemical cell comprising the metal recovery electrode of claim 17 as a working electrode, the spent electrode as a counter-electrode, and an electrolyte between the working electrode and the counter-electrode, and
B) applying a potential or a current between the working electrode and the counter-electrode to dissolve the metal from the spent electrode and electrodeposit dissolved atoms of the metal on the metal recovery electrode, thereby recovering the metal and forming a composite electrode.
